(19) United States
(12) Patent Application Publication
(10) Pub. No.: US 2009/0148714 A1
(43) Pub. Date: Jun. 11, 2009

(54) METHOD OF PREPARING HIGH DENSITY METAL OXIDE LAYERS AND THE LAYERS PRODUCED THEREBY

(75) Inventors: Andrew B. Bocarsly, Plainsboro, NJ (US); Brent Kirby, Kennewick, WA (US); David Dowling, Coconut Grove, FL (US)

Correspondence Address: OBLON, SPIVAK, MCCLELLAND MAIER & NEUSTADT, P.C., 1940 DUKE STREET, ALEXANDRIA, VA, 22314, US

(73) Assignees: APPLIED SEMICONDUCTOR INTERNATIONAL LTD., Neuenhof (CH); The Trustees of Princeton University, Princeton, NJ (US)

(21) Appl. No.: 12/206,210

(22) Filed: Sep. 8, 2008

Related U.S. Application Data
(60) Provisional application No. 60/970,555, filed on Sep. 7, 2007.

(51) Int. Cl. C01D 1/02; B32B 15/04

(52) U.S. Cl. 428/471; 204/157.51; 428/472; 428/469

(57) ABSTRACT

A method for the production of an oxide layer, involving oxidizing a metal surface, wherein the metal surface is electrically connected to an electronic control unit (ECU);
wherein the metal oxide layer produced has an amount of metal present in said metal oxide layer that is higher than that present in a metal oxide layer produced by oxidizing the metal surface in the absence of the ECU; or
oxidizing an oxidizable non-metallic conductive surface, wherein the oxidizable non-metallic conductive surface is electrically connected to an electronic control unit (ECU);
wherein the oxide layer produced is denser than that produced by oxidizing the oxidizable non-metallic conductive surface in the absence of the ECU;
and the metal oxide or oxide layers produced thereby.

### BACKGROUND OF THE INVENTION

1. Field of Invention

The present invention relates to a method for the production of dense oxide layers, preferably of metal oxide, and the use of those layers in applications including, but not limited to, semiconductors, corrosion suppression and other oxide coating applications.

2. Discussion of the Background

Corrosion is a costly problem worldwide. Studies of the costs of corrosion have been undertaken in various countries and estimates range from 2-5% of gross national product. Corrosion of steel is chief among these issues, affecting buildings, roads, bridges, vehicles, ships, etc. Prevention of steel corrosion is in itself a huge industry. Any advances in corrosion protection have the potential for significant impact on global economies.

Zinc is commonly used as a protective coating on steel in the galvanization process. The more reactive zinc preferentially corrodes leaving the underlying steel intact. Hot dip galvanization leaves a thin layer of zinc over the entire surface. Other coating systems are more complex utilizing a zinc rich coating primer, often an adhesive mid-coat, and a barrier topcoat. The discussion here will focus on the properties of the zinc rich coating.

Galvanic protection of steel by zinc in electrical contact is one form of cathodic protection. That is, the more active zinc preferentially corrodes, becoming the anode in the galvanic couple, and protects the steel by maintaining it as the cathode. The impressed current technique is another form of cathodic protection in which an external power source is used to constantly supply electrons to the steel, again maintaining it as a cathode and preventing iron dissolution.

Zinc rich coatings (ZRC's) have long been employed to prevent corrosion on steel structures (Munger, C. G.; Vincent, L. D. Corrosion Prevention by Protective Coatings; 2nd ed.; NACE: Houston, 1999). ZRC's comprise zinc dust (typically >80% by weight) bound in an inorganic (e.g. ethyl silicate) or an organic (e.g. epoxy) binder. It is widely accepted that protection occurs initially by sacrificial galvanic protection offered by the zinc particles which are electrically connected to each other and to the steel substrate (Feliu, S.; Baraj as, R.; Bastidas, J. M.; Morcillo, M. Journal of Coatings Technology 1989, 61, 63-69). After a period of weeks or months, zinc corrosion products build up within and on top of the ZRC, resulting in a barrier layer (Feliu, S.; Barajas, R.; Bastidas, J. M.; Morcillo, M. Journal of Coatings Technology 1989, 61, 71-76). This physical prevention of access by corrosive species to the underlying steel becomes the primary means of corrosion inhibition.

The ECU (electronic control unit) concept was originally developed in a crude form by Riffe (Riffe, W. J. U.S. Pat. No. 5,055,165, 1991), and was later refined by Dowling et al (U.S. Pat. Nos. 6,562,201; 6,811,681 and others).

Dowling, U.S. Pat. No. 6,562,201 considers the electronic filtering provided by the capacitor in the circuit. It is argued that by suppressing the random voltage fluctuations (electrochemical noise) associated with the corrosion process, corrosion proceeds more slowly and the life of the coating is extended. Dowling and Khorrami, U.S. Pat. No. 6,811,681, report an active tunable device to match the frequency response of the ECU to that of the corrosion noise experienced by each object to be protected.

### SUMMARY OF THE INVENTION

Accordingly, one object of the present invention is to provide a method for the production of metal oxide layers having a density of the metal in the oxide layer that is higher than would normally occur under ambient oxidation conditions.

A further object of the present invention is to provide a method for the production of dense metal oxide layers that can use metal in any form as the starting material.

A further object of the present invention is to provide a method for the production of a dense oxide layer of a metal alloy or mixture.

A further object of the present invention is to provide a method for production of a dense oxide layer on a non-metallic conductive substrate capable of forming oxides.

A further object of the present invention is to provide dense oxide layers produced by the method of the present invention.

These and other objects of the present invention, either individually or in combinations thereof, have been satisfied by the discovery of a method for the production of a metal oxide layer, comprising:

oxidizing a metal surface, wherein the metal surface is electrically connected to an electronic control unit (ECU);

wherein the metal oxide layer produced has an amount of metal present in said metal oxide layer that is higher than that present in a metal oxide layer produced by oxidizing the metal surface in the absence of the ECU; or

a method for the production of an oxide layer, comprising:

oxidizing an oxidizable non-metallic conductive surface, wherein the oxidizable non-metallic conductive surface is electrically connected to an electronic control unit (ECU);

wherein the oxide layer produced is denser than that produced by oxidizing the oxidizable non-metallic conductive surface in the absence of the ECU;

and the oxide or metal oxide layers produced thereby.

### BRIEF DESCRIPTION OF THE FIGURES

A more complete appreciation of the invention and many of the attendant advantages thereof will be readily obtained as the same becomes better understood by reference to the following detailed description when considered in connection with the accompanying drawings, wherein:

FIG. 1 shows a photomicrograph of a control plate having a zinc/zinc oxide/aluminum silicate coating after one year of corrosion in the absence of an ECU, and a line scan showing x-ray counts for each element, terminating in a pure zinc particle, showing that the oxide near the interface contains 37.7% of the zinc in a pure zinc particle.

FIG. 2 shows a photomicrograph of a plate after one year of corrosion while connected to an ECU of the present invention, and a line scan showing x-ray counts for each element, terminating in a pure zinc particle, showing that the oxide near the interface contains 49.1% of the zinc in a pure zinc particle.

FIG. 3 shows cross-sectional SEM images of control plates at 1600× magnification, wherein cracks are visible where the oxide barrier layer meets the substrate, as indicated by the arrows.

FIG. 4 shows cross-sectional SEM images of ECU plates at 1600× magnification, wherein there is superior adhesion of the oxide barrier layer to the substrate and no cracks are visible.

### DETAILED DESCRIPTION OF THE INVENTION

The invention is a process to grow a dense oxide layer on metal rich paints and/or surfaces of metal. Within the context of the present invention, the metal in the metal rich paint or the metal surface can be a single metal, a metal alloy or a metal mixture.

The oxide layer produced by the present process is more dense than that which would grow with no intervention. Density of the oxide layer is determined by measuring the amount of the metal (or metal allow or mixture) within the oxide layer relative to the amount contained within the pure metal itself. The oxide layers of the present invention thus have higher amounts of the metal, alloy or metal mixture present in the oxide structure than conventionally occurs under ambient oxidation conditions.

The process of the present invention comprises application to the metal containing surface (whether a metal rich paint, metal sheet, or other metal object) of an electronic control unit, as described in U.S. Pat. Nos. 6,325,915; 6,562,201 and 6,811,681, the entire contents of each of which are hereby incorporated by reference. Such electronic control units (ECU's) have been shown in these cited patents to be useful to prevent corrosion. However, the present inventors have found that by connecting the ECU to the metal containing surface while under oxidation conditions, one can grow a dense oxide layer on the surface that is denser in its content of metal than would occur under ambient oxidation conditions in the absence of the ECU.

Growing a dense oxide layer on metal is useful for corrosion protection on any metal coated products, such as zinc coatings used in galvanized steel. The metal in the present invention metal rich paint or metal surface can be any metal that oxidizes at ambient conditions. Preferred metals include, but are not limited to, one or more metals selected from the group consisting of Zn, Ti, Al, Ga, Ce, Mg, Ba, Cu and Cs, and alloys and mixtures thereof, with most preferred metals including, but not limited to, Zn, Ti, Mg, Al and alloys and mixtures thereof.

The present invention can be performed on objects that are made entirely of the metal, metal alloy or metal mixture, or can be performed on objects comprising a substrate on which the metal, metal alloy or metal mixture are present. In addition to using metal, metal alloy or metal mixture, the present invention can use a coating that contains metal and metal oxide in a binder, such as the metal/metal oxide/binder coatings discussed in Dowling's U.S. Pat. No. 6,325,915, U.S. Pat. No. 6,402,933, U.S. Pat. No. 6,551,491 and U.S. Pat. No. 6,562,201, the entire contents of each of which is hereby incorporated by reference.

In an alternative embodiment, the substrate can be an oxidizable non-metallic conductive (or semiconductive) substrate that forms oxides under oxidizing conditions. In that case, the oxide layer is more dense with the use of the present invention process (i.e. with the ECU) compared to the oxide layer produced when the non-metallic conductive substrate is permitted to oxidize in the absence of the ECU.

The dense metal oxide layers prepared by the present process can be used in a variety of metal oxide applications such as the preparation of a dense polycrystalline semiconductor. The present process could further be used as a pretreatment for any variety of metal coated materials. It also can be used in the production of metal oxide semiconductors for applications including, but not limited to, thin film solar cells or gas sensors for combustion. The present invention process can be used in concert with other metal deposition techniques including sputtering or chemical vapor deposition, or other methods for generating layers or surfaces of metal, which can then be oxidized under the present invention process.

The present invention process will now be described with respect to the use of zinc or zinc coated metal in the production of a dense zinc oxide layer. However, the discussion below is provided for illustrative purposes only and is not intended to limit the present invention to the use of zinc or zinc alloys only.

The present invention process involves electrically connecting the ECU with the zinc or zinc coated metal in question. The oxide layer begins to grow when the zinc is exposed to a corrosive environment.

Different corrosive environments (salt spray, salt water, fresh water, etc.) will lead to different compositions of the oxide layer due to elemental differences in the environment. For example, if salt water or salt spray is used, the dense oxide layer will contain certain levels of Cl⁻, typically present as ZnCl. Layers of specific composition can also be tailored and grown, if desired, by specifying and controlling the corrosive environment conditions.

Metallic coatings, such as zinc coatings, protect underlying metals first by galvanic action and later by creating a barrier of zinc corrosion products that seal off the surface from the environment. Typically, this barrier layer grows over time under the ambient environmental conditions. With the application of the ECU in accordance with the present invention, the growth process of the barrier layer is affected, conserving zinc, and surpisingly, increasing the amount of zinc in the oxide layer generated. Although applicants do not wish to be bound to any theory of operation of the present process, it is believed that since zinc oxide is typically understood to be a combination of ZnO and Zn(OH)₂, the present invention process results in a more compact and dense zinc oxide layer by altering the relative amounts of production of the ZnO and Zn(OH)₂, with more of the ZnO being produced in the presence of the ECU than under non-ECU conditions. The resulting layer of oxide in the present invention has significantly higher levels of the zinc present, and has been shown experimentally to be a more tightly packed, denser oxide layer.

Experimental evidence confirms that by employing the present process using the ECU, a layer is formed which is significantly more dense than a layer grown without the ECU. The interaction of the ECU with oxide growth could also be extended to any process where the passivation of the metal, metal alloy or metal mixture or the production of dense metal oxide is required.

Having generally described this invention, a further understanding can be obtained by reference to certain specific examples which are provided herein for purposes of illustration only and are not intended to be limiting unless otherwise specified.

### EXAMPLES

### Density and Adhesion of the Oxide Barrier Layer

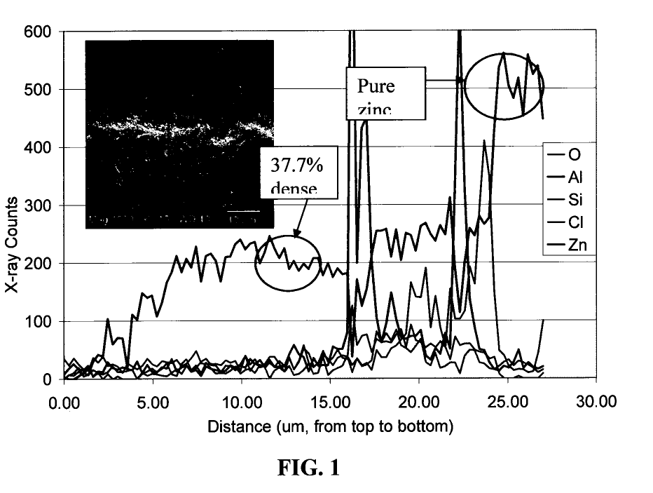

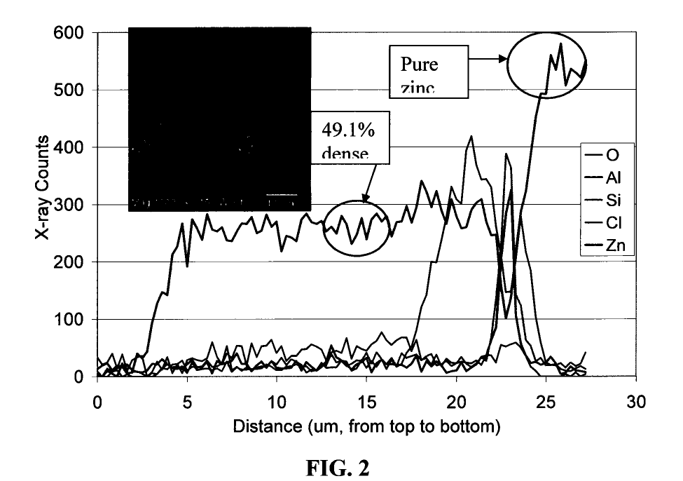

Scanning electron microscopy (SEM) and elemental analysis by energy dispersive x-ray analysis (EDX) show that the ECU facilitates the formation of a denser zinc oxide layer (taken to mean ZnO and/or Zn(OH)₂) as compared to the control (FIGS. 1 and 2). The average density of zinc in the oxide layer was 40.4%±4.7% for control plates and 47.6%+4.3% for ECU plates (see below for the experimental procedure). A statistical t-test on these distributions yields a 99.99% probability that the two averages are statistically different.

Samples were prepared by cleaning, then coating steel plates with a zinc/zinc oxide/aluminum silicate coating, and then subjecting the plates to one year of corrosion in 3% NaCl solution at pH 7. Controls had no ECU attached, while test samples had the ECU attached during the one year of corrosion. Sixteen EDX line scans consisting of 100 points each were taken across three control plates. Similarly, sixteen line scans were taken across three ECU plates. Lines were selected to end within an area known to be pure zinc, providing a baseline average for x-ray counts from pure zinc. For the oxide layer, an average of zinc x-ray counts was taken for the ten points just above the interface with the substrate. The location of the interface was indicated by a rise in the Al, Si, or Cl signals; Al and Si are present in the aluminum silicate binder, and Cl is evident in the ZnCl left behind when a zinc particle corrodes in place. The ratio of the average zinc x-ray counts from the oxide to that from the zinc particles yielded a zinc “density” in the oxide layer, expressed as a percentage vs. pure zinc.

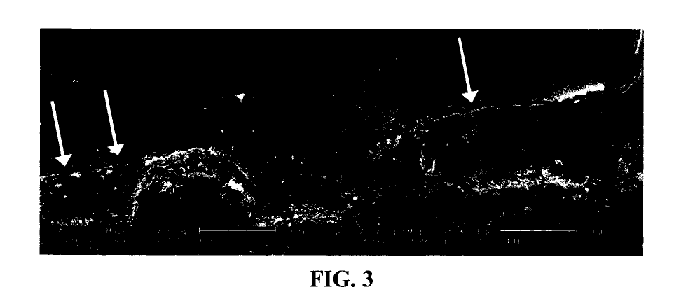

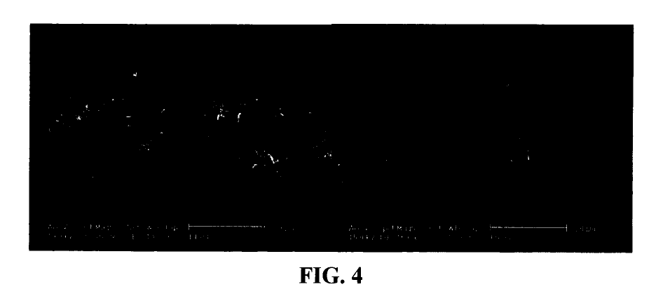

ECU samples also showed superior adhesion of the oxide layer to the substrate. Significant cracks were often observed at the oxide/substrate interface for the control samples (FIG. 3), while the ECU samples showed very few such cracks (FIG. 4). This may be due to faster growth in the control oxide due to more rapid corrosion, or a direct effect of the ECU on oxide formation process itself.

Obviously, additional modifications and variations of the present invention are possible in light of the above teachings. It is therefore to be understood that within the scope of the appended claims, the invention may be practiced otherwise than as specifically described herein.

1. A method for the production of a metal oxide layer, comprising:
oxidizing a metal surface, wherein the metal surface is electrically connected to an electronic control unit (ECU);
wherein the metal oxide layer produced has an amount of metal present in said metal oxide layer that is higher than that present in a metal oxide layer produced by oxidizing the metal surface in the absence of the ECU.

2. The method of claim 1, wherein the metal surface comprises a one or more of a metal, a metal alloy, or a metal mixture.

3. The method of claim 1, wherein the metal surface is a metal surface formed on an underlying substrate.

4. The method of claim 3, wherein the underlying substrate is a conductive substrate.

5. The method of claim 3, wherein the underlying substrate is a non-conductive substrate.

6. The method of claim 3, wherein the metal surface is a coating comprising a metal/metal oxide/binder resin structure.

7. The method of claim 1, wherein the metal surface comprises one or more metals selected from the group consisting of Zn, Ti, Al, Ga, Ce, Mg, Ba, Cu and Cs, and alloys and mixtures thereof.

8. The method of claim 7, wherein the metal surface comprises one or more metals selected from the group consisting of Zn, Ti, Mg, Al and alloys and mixtures thereof.

9. The method of claim 8, wherein the metal surface comprises one or more metals selected from the group consisting of Zn and alloys and mixtures thereof.

10. The method of claim 6, wherein the metal/metal oxide/binder structure comprises zinc/zinc oxide/aluminum silicate.

11. A method for the production of an oxide layer, comprising:
oxidizing an oxidizable non-metallic conductive surface, wherein the oxidizable non-metallic conductive surface is electrically connected to an electronic control unit (ECU);
wherein the oxide layer produced is denser than that produced by oxidizing the oxidizable non-metallic conductive surface in the absence of the ECU.

12. A metal oxide layer produced by the method of claim 1.

13. An oxide layer produced by the method of claim 11.

14. A semiconductor component having a metal oxide layer produced by the method of claim 1.
